(19) United States
(12) Patent Application Publication
(10) Pub. No.: US 2025/0309279 A1
(43) Pub. Date: Oct. 2, 2025

(54) MANUFACTURING METHOD FOR MEMBRANE ELECTRODE ASSEMBLY AND MEMBRANE-ELECTRODE ASSEMBLY

(71) Applicant: HONDA MOTOR CO., LTD., Tokyo (JP)

(72) Inventors: Junya OCHIAI, Tokyo (JP); Junko Tanaka, Tokyo (JP); Keiichi IIO, Tokyo (JP); Hideaki ONDA, Tokyo (JP); Kazutoshi MAMEDA, Tokyo (JP)

(21) Appl. No.: 19/063,526

(22) Filed: Feb. 26, 2025

(30) Foreign Application Priority Data
Mar. 29, 2024 (JP) 2024-058309

(51) Int. Cl. H01M 4/88; H01M 8/1004

(52) U.S. Cl. CPC H01M 4/8825; H01M 4/8803; H01M 4/8878; H01M 8/1004

(57) ABSTRACT

A manufacturing method for a membrane electrode assembly includes: a placing-frame-member step of placing a frame member on a suction plate; a placing-electrode-catalyst-layer step of placing an electrode catalyst layer on the frame member so as to have a circumferential edge of the electrode catalyst layer overlapped with a margin of an opening of the frame member; a placing-electrolyte-membrane step of placing an electrolyte membrane on an opposite side of the electrode catalyst layer to the frame member; and a peeling-protective-sheet step of peeling a protective sheet. A circumferential edge of the electrolyte membrane is placed beyond that of the electrode catalyst layer. A two-layer portion of the frame member and electrolyte membrane and a three-layer portion of the frame member, electrode catalyst layer, and electrolyte membrane are sequentially formed in the placing-electrolyte-membrane step from the circumferential edge of the electrolyte membrane to the margin of the opening.

### CROSS-REFERENCE TO RELATED APPLICATION

This application claims the benefit of priority under 35 U.S.C. § 119 to Japanese Patent Application No. 2024-058309 filed on Mar. 29, 2024, the entire contents of which are incorporated herein by reference.

### TECHNICAL FIELD

The present invention relates to a manufacturing method for a membrane electrode assembly for a fuel cell and a membrane electrode assembly for a fuel cell.

### BACKGROUND OF THE INVENTION

An electrolyte membrane in a membrane electrode assembly of a fuel cell is generally a very thin flexible sheet to be easily deformed due to influence from humidity and ambient temperature, to affect performance in generating electricity if foreign particles are attached to its surface. For this reason, the electrolyte membrane has a protective sheet affixed thereto in order to protect a surface thereof.

As for a manufacturing method for a membrane electrode assembly, there is a known method of applying slurry for an electrode catalyst layer to a peelable sheet to form an electrode catalyst layer and then transferring an electrode contact layer to an electrolyte membrane through thermal compression bonding (see Japanese Patent No. 3465209, for example). As described above, a sheet is used for a membrane electrode assembly of a fuel cell.

FIG. 9 is a schematic cross-sectional view of key portions to show a conventional assembly of a membrane electrode assembly for a fuel cell. FIG. 10 is a schematic cross-sectional view of key portions to illustrate a protective sheet provided on the membrane electrode assembly being peeled.

As shown in FIG. 9, a membrane electrode assembly 100 is formed by bonding, with a bonding layer 400, a membrane electrode laminate 200, composed of an electrode catalyst layer 210 and an electrolyte membrane 220, with a frame member 300. The membrane electrode assembly 100 is covered by a protective sheet 500. The protective sheet 500 is then pulled up and peeled with an adhesive tape 600.

### SUMMARY

### Problems to be Solved

However, when the protective sheet 500 is peeled with the adhesive tape 600 being pulled upward, a peeling load F100 is applied to a boundary surface between the protective sheet 500 and electrolyte membrane 220. Additionally, an interface strength F200 is applied to inside the electrode catalyst layer 210, a boundary surface between the electrolyte membrane 220 and electrode catalyst layer 210, and a boundary surface between the electrode catalyst layer 210 and frame member 300.

At this time, there has been a problem that the interface strength F200 between the electrolyte membrane 220 and electrode catalyst layer 210, and between the electrode catalyst layer 210 and frame member 300 succumbs to the peeling load F100 to the protective sheet 500, to cause peeling between the boundary surfaces. When the protective sheet 500 is peeled, electrode destruction 210a could be induced inside the electrode catalyst layer 210.

Then, the present invention is intended to provide a manufacturing method for a membrane electrode assembly and a membrane electrode assembly to reduce influence on the electrode catalyst layer when the protective sheet is peeled.

### Solution to Problems

As a means of solving the above-described problems, the present invention provides a manufacturing method for a membrane electrode assembly to join an electrolyte membrane, having a protective sheet affixed thereto, and an electrode catalyst layer laminated on an opposite side of the electrolyte membrane to the protective sheet with a frame member having an opening in the center and layered with circumferential portions of the electrolyte membrane and electrode catalyst layer to manufacture a membrane electrode assembly, the method including: a placing-frame-member step of placing the frame member on a suction plate; a placing-electrode-catalyst-layer step of placing the electrode catalyst layer on the frame member so as to have a circumferential edge of the electrode catalyst layer overlapped with a margin of the opening; a placing-electrolyte-membrane step of placing an electrolyte membrane on an opposite side of the electrode catalyst layer to the frame member; and a peeling-protective-sheet step of peeling the protective sheet after the electrolyte membrane has been laminated, wherein a circumferential edge of the electrolyte membrane is placed beyond the circumferential edge of the electrode catalyst layer, and a two-layer portion, having the frame member layered with the electrolyte membrane, and a three-layer portion, having the frame member layered with the electrode catalyst layer and electrolyte membrane, are sequentially formed in the placing-electrolyte-membrane step from the circumferential edge of the electrolyte membrane to the margin of the opening.

### Advantageous Effects of the Invention

The present invention provides a manufacturing method for a membrane electrode assembly and a membrane electrode assembly to reduce influence on the electrode catalyst layer when the protective sheet is peeled.

### BRIEF DESCRIPTION OF DRAWINGS

FIG. 1 is a schematic cross-sectional view of key portions, with an adhesive tape stuck to a protective sheet; to illustrate a manufacturing method for a membrane electrode assembly and a membrane electrode assembly according to an embodiment of the present invention;

FIG. 2 is a schematic cross-sectional view of the key portions having the protective sheet pulled up with the adhesive tape so as to be peeled from an electrolyte membrane;

FIG. 3 is a schematic cross-sectional view of the key portions having the protective sheet shown in FIG. 2 further pulled up with the adhesive tape;

FIG. 4 shows key portions in FIG. 2 enlarged;

FIG. 5A is a plan view of the protective sheet, affixed to the membrane electrode assembly, having been arranged;

FIG. 5B is a cross-sectional view, taken along a line VB-VB in FIG. 5A;

FIG. 5C is a cross-sectional view, taken along a line VC-VC in FIG. 5A;

FIG. 6 is a chart showing interface strength of members of the membrane electrode assembly;

FIG. 7A is a schematic plan view of the membrane electrode assembly to illustrate a positioning-protective-sheet step of the manufacturing method for a membrane electrode assembly;

FIG. 7B is a schematic cross-sectional view of the membrane electrode assembly to illustrate a suctioning step of the manufacturing method for a membrane electrode assembly;

FIG. 7C is a schematic cross-sectional view to illustrate a holding-and-cutting-adhesive-tape step of the manufacturing method for a membrane electrode assembly;

FIG. 7D is a schematic cross-sectional view to illustrate a correcting-tape-posture step of the manufacturing method for a membrane electrode assembly;

FIG. 7E is a schematic cross-sectional view of the key portions to illustrate a sticking-adhesive-tape step of the manufacturing method for a membrane electrode assembly;

FIG. 7F is a schematic cross-sectional view of the key portions to illustrate a peeling-protective-sheet step of the manufacturing method for a membrane electrode assembly;

FIG. 7G is a schematic plan view to illustrate a peeling-protective-sheet step of the manufacturing method for a membrane electrode assembly;

FIG. 8 is a cross-sectional view, to illustrate a modification of the membrane electrode assembly;

FIG. 9 is a schematic cross-sectional view of key portions to show a conventional structure of a membrane electrode assembly for a fuel cell; and

FIG. 10 is a schematic cross-sectional view of enlarged key portions to illustrate a protective sheet provided on the membrane electrode assembly being peeled.

### DETAILED DESCRIPTION

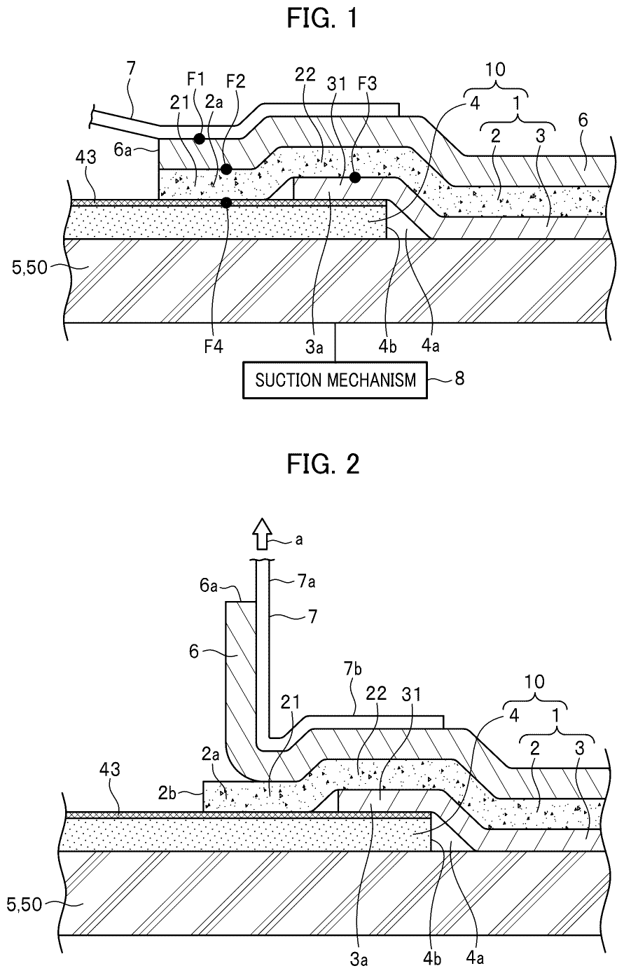

Hereinafter, a description is given of a manufacturing method for a membrane electrode assembly 10 and the membrane electrode assembly 10 according to an embodiment of the present invention, with reference to FIG. 1. For the purpose of illustration, the description is given, with a vertically upper side of the membrane electrode assembly 10 in FIG. 1 as “UP,” a vertically lower side as “DOWN,” width directions as “LEFT” and “RIGHT” Herein below, members common in the drawings are denoted by the same reference signs and descriptions thereof are skipped.

### <<Membrane Electrode Assembly>>

The membrane electrode assembly 10 is used in a solid polymer fuel cell. The membrane electrode assembly 10 is formed by joining a membrane electrode laminate 1 with a frame member 4. The membrane electrode assembly 10 is placed on a suction plate 5.

### <Membrane Electrode Laminate>

The membrane electrode laminate 1 is composed of an electrolyte membrane 2 having a protective sheet 6 affixed to one surface thereof, and an electrode catalyst layer 3 laminated on the other surface of the electrolyte membrane 2. The membrane electrode laminate 1 is manufactured by joining together the electrolyte membrane 2, frame member 4 joined to a circumferential edge 2a of the electrode membrane 2, and electrode catalyst layer 3.

### <Suction Plate>

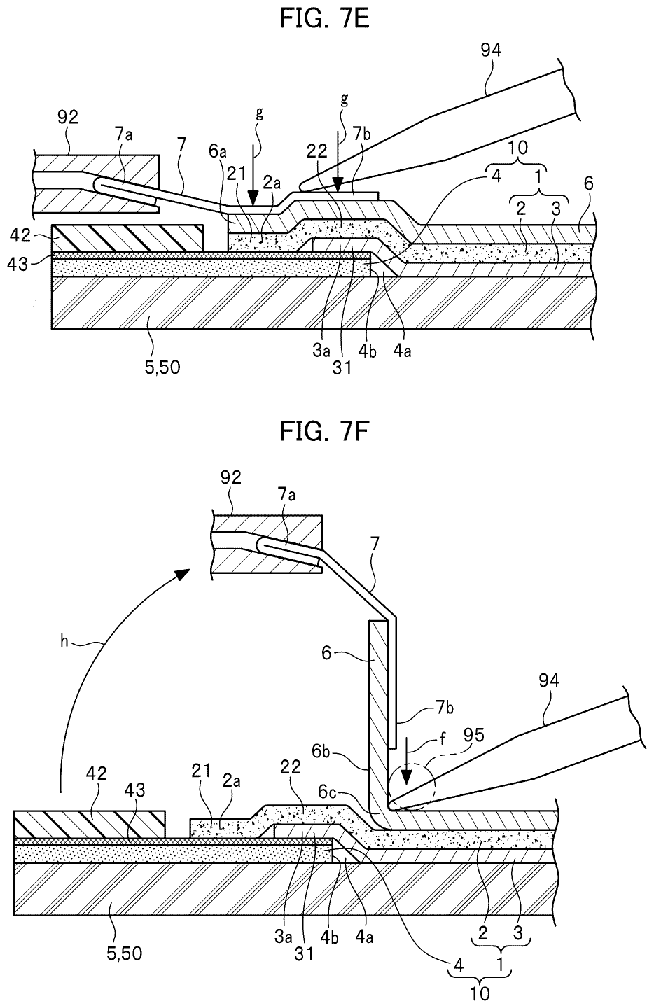

The suction plate 5 is a plate member formed with a member having air permeability. A suction mechanism 8 to suction the suction plate 5 is provided below the suction plate 5. Accordingly, the suction mechanism 8 suctioning the suction plate 5 downward causes the electrode catalyst layer 3, and electrolyte membrane 2 with the protective sheet 6 to be suctioned to the suction plate 5 (see FIG. 7B). The suction plate 5 is also a part of a conveying mechanism 50 to convey the membrane electrode laminate 1.

### <Suction Mechanism>

As shown in FIG. 1, the suction mechanism 8 is a suction device to suction the electrode catalyst layer 3 and electrolyte membrane 2 via the suction plate 5, when the protective sheet 6 is peeled from the electrode membrane 2, to prevent undesired peeling (see FIG. 7B).

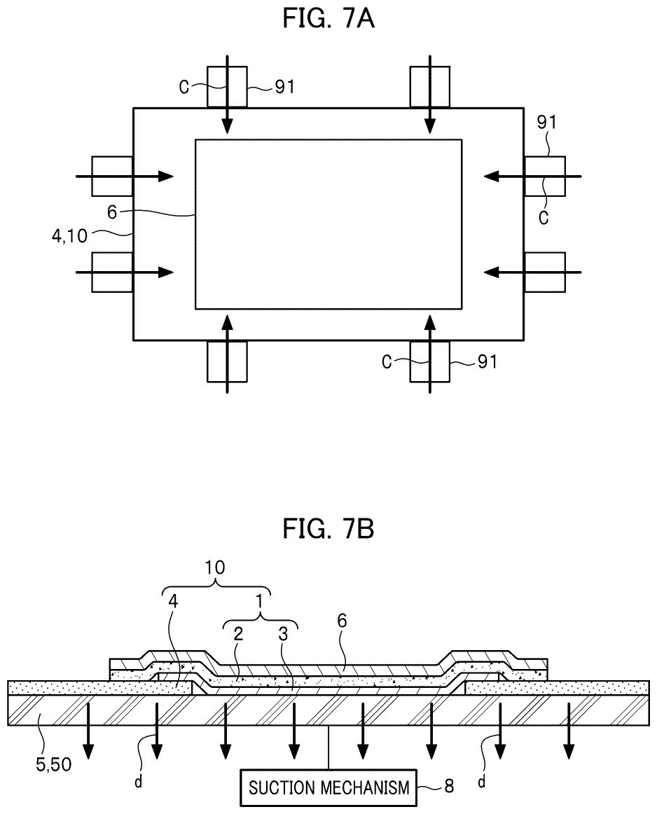

FIG. 5A is a plan view of the protective sheet 6, affixed to the membrane electrode assembly 10, having been arranged. FIG. 5B is a cross-sectional view, taken along a line VB-VB in FIG. 5A. FIG. 5C is a cross-sectional view, taken along a line VC-VC in FIG. 5A.

### <Plate Member>

As shown in FIG. 1, the plate member 4 is a sub-gasket to be integrally joined to a circumferential portion of the electrolyte membrane 2. The frame member 4 is composed of a rim-like member, in a substantially rectangular shape, having an opening 4a in the center and formed to extend along the circumferential portion of the electrolyte membrane 2 so as to enclose the electrolyte membrane 2 (see FIGS. 5A to 5C). The frame member 4 is formed of a resin film in a sheet shape. The frame member 4 is joined to the circumferential edge 2a of the electrolyte membrane 2 and placed on the suction plate 5. The frame member 4 is provided on a top surface thereof with a bonding layer 43 to bond a circumferential edge 3a of the electrode catalyst layer 3 and the circumferential edge 2a of the electrolyte membrane 2 to the frame member 4.

### <Electrode Catalyst Layer>

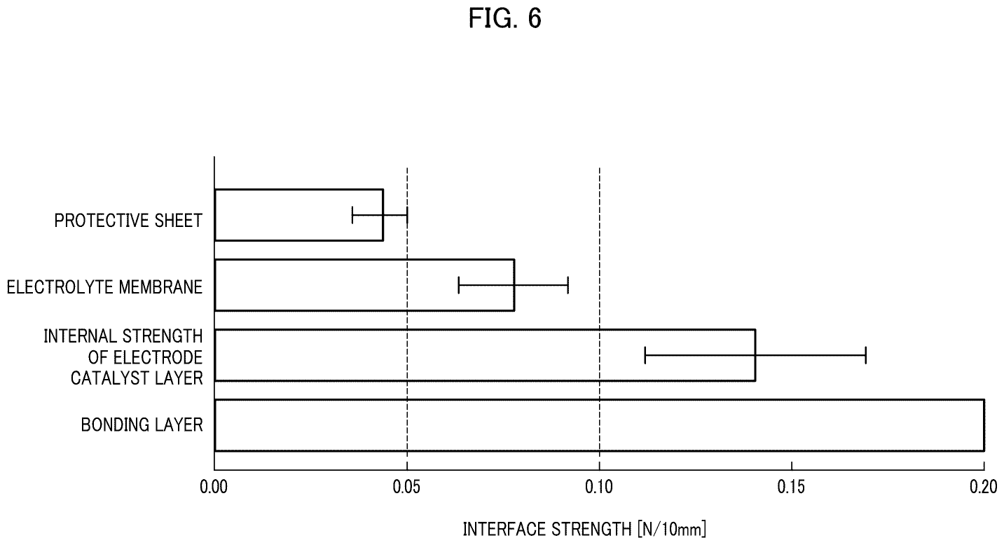

The electrode catalyst layer 3 is composed of a porous member having permeability of allowing gas to pass through. The electrode catalyst layer 3 has the electrolyte membrane 2 placed thereon. The electrode catalyst layer 3 has the suction plate 5 having air permeability arranged thereunder. Accordingly, the electrode catalyst layer 3 is configured such that the suction plate 5 and electrode catalyst layer 3 are suctioned by the suction mechanism 8 provided below the suction plate 5 to allow the electrolyte membrane 2 to be suctioned to the electrode catalyst layer 3. In this manner, the electrode catalyst layer 3 is suctioned toward the suction plate 5 by the suction mechanism 8, to prevent it from being lifted (see FIG. 4). The electrode catalyst layer 3 has an overlayed portion 31 having the circumferential edge 3a placed on a margin 4b of the opening 4a of the frame member 4 to cause the electrode catalyst layer 3 to be overlapped with the frame member 4. In the fuel cell using the membrane electrode laminate 1, a pair of the electrode catalyst layers 3 are included on both sides of the electrolyte membrane 2, with one of the pair of the electrode catalyst layers 3 working as an anode and the other working as a cathode. Note that either of the electrode catalyst layers 3 is not shown in any of FIGS. 1 to 7.

### <Electrolyte Membrane>

The electrolyte membrane 2 in FIG. 1 is composed of a rectangular sheet which is very thin and flexible and thus easily deformed (see FIGS. 5A to 5C). The electrolyte membrane 2 is formed of perfluoro sulfonic acid polymers such as Nafion (registered trademark). The circumferential edge 2a of the electrolyte membrane 2 is placed beyond the circumferential edge 3a of the electrode catalyst layer 3. A portion of the membrane electrode assembly 10, having the circumferential edge 2a of the electrolyte membrane 2 layered with the frame member 4, is referred to as a two-layer portion 21. Likewise, a portion of the membrane electrode assembly 10, having the electrolyte membrane 2 and the circumferential edge 3a of the electrode catalyst layer 3 layered with the frame member 4, inside the two-layer portion 21 is referred to as a three-layer portion 22. The two-layer portion 21 and three-layer portion 22 are sequentially formed from the circumferential edge 2a of the electrode catalyst layer 2 to the margin 4b of the opening 4a.

### <Protective Sheet>

The protective sheet 6 is a back film to cover and protect a surface of the membrane electrode assembly 10. The protective sheet 6 covers the electrolyte membrane 2 to prevent foreign particles from attaching to the electrolyte membrane 2. The protective sheet is laminated on the electrode catalyst layers 3 via the electrolyte membrane 2 and then peeled from the electrolyte membrane 2.

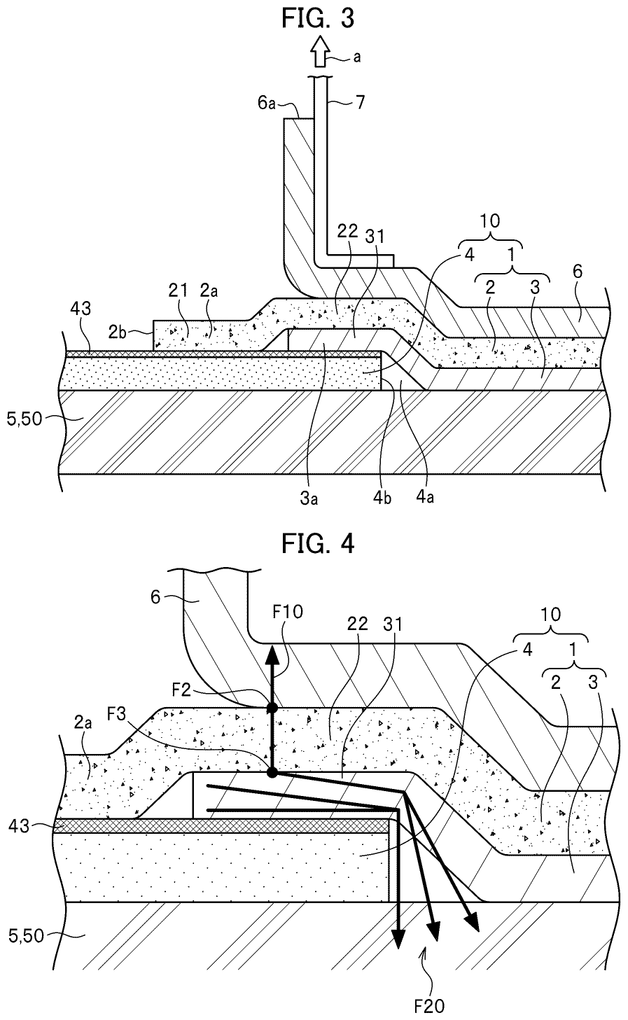

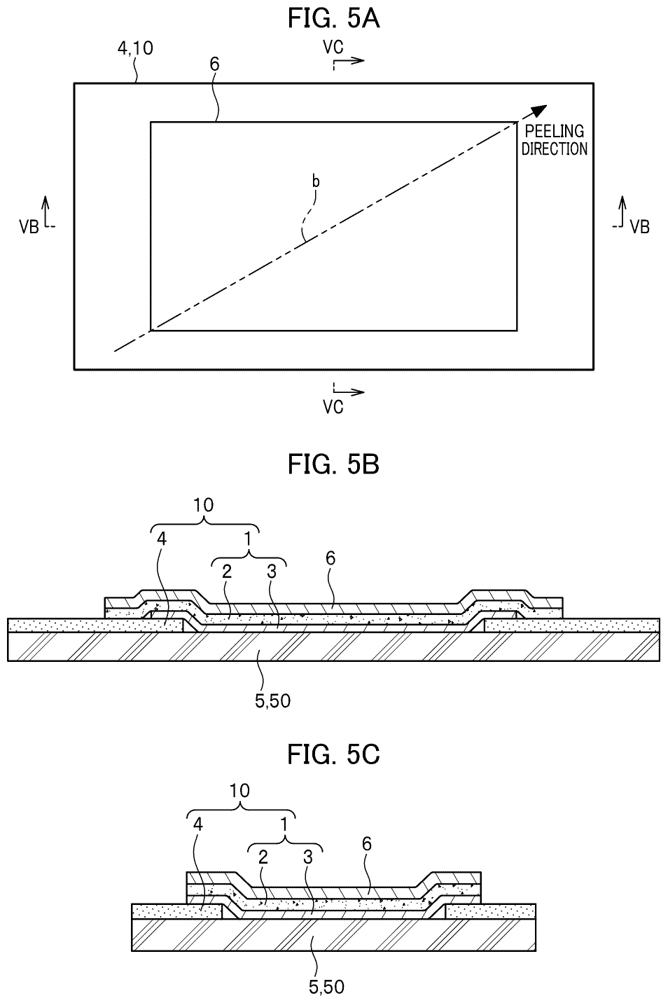

FIG. 2 is a schematic cross-sectional view of key portions having the protective sheet 6 pulled up with an adhesive tape 7 so as to be peeled from the electrolyte membrane 2. FIG. 3 is a schematic cross-sectional view of the key portions having the protective sheet 6 shown in FIG. 2 further pulled up with the adhesive tape 7. FIG. 4 shows key portions in FIG. 2 enlarged.

### <Adhesive Tape>

As shown in FIGS. 1 and 2, the adhesive tape 7 is a tape used to peel the protective sheet 6 affixed to the electrolyte membrane 2. The adhesive tape 7 is stuck on an outermost edge 6a of the protective sheet 6 so as to be removed when required. As shown in FIGS. 2 to 4, the adhesive tape 7 is preferably peeled in a diagonal direction (direction indicated by an arrowed line “b”) with respect to the protective sheet 6 in a rectangular shape, while a corner 6b (see FIG. 7G) of an outermost edge 6a of the protective sheet 6 being pulled up.

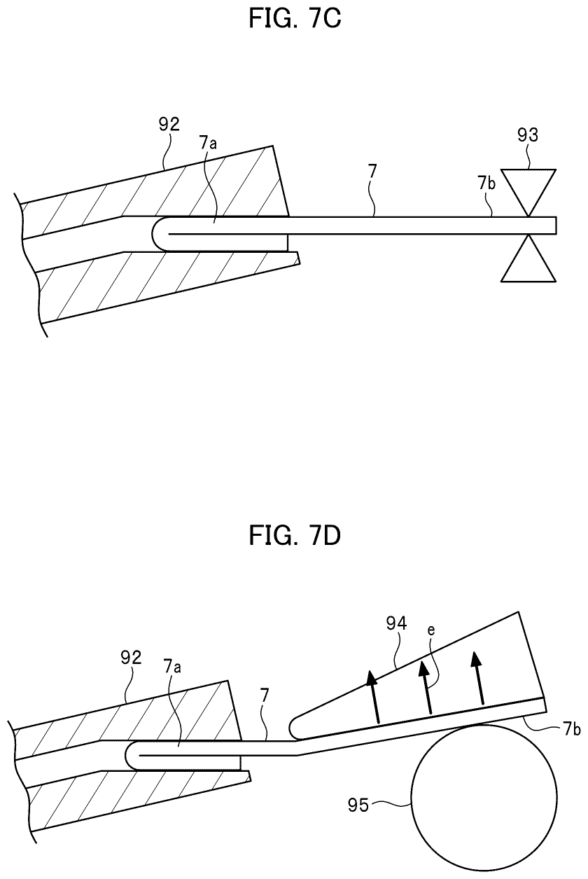

FIG. 6 is a chart showing interface strength of members of the membrane electrode assembly 10. As shown in FIG. 6, the members of the membrane electrode assembly 10 is set to have larger interface strength in order of the protective sheet 6, electrolyte membrane 2, electrode catalyst layer 3, and bonding layer 43.

### <<Manufacturing Method for Membrane Electrode Assembly>>

Next, a description is given of a manufacturing method for the membrane electrode assembly 10 in order of steps. Note that the order of processing with the manufacturing method is merely an example and may be suitably altered.

<Placing-frame-member Step>

When the membrane electrode assembly 10 is manufactured, a placing-frame-member step of placing the frame member 4 on the suction plate 5 is executed first, as shown in FIG. 1.

### <Positioning-Frame-Member Step>

FIG. 7A is a schematic plan view of the membrane electrode assembly 10 to illustrate a positioning-frame-member step of the manufacturing method for the membrane electrode assembly 10. Next, the positioning-frame-member step is executed to position the frame member 4 on the suction plate 5, with the frame member 4 pressed by floating devices 91 with clamping forces C from all around, to align an outer edge of the frame member 4 with a predetermined position.

### <Placing-Electrode-Catalyst-Layer Step>

Subsequently, a placing-electrode-catalyst-layer step is executed to place the electrode catalyst 3 on the frame member 4 so as to have the circumferential edge 3a of the electrode catalyst layer 3 overlapped with the margin 4b of the opening 4a.

### <Placing-Electrolyte-Membrane Step>

Next, a placing-electrolyte-membrane step is executed to place the electrolyte membrane 2 on the opposite side of the electrode catalyst layer 3 to the frame member 4. In the placing-electrolyte-membrane step, the two-layer portion 21, including the frame member 4 and electrolyte membrane 2, and the three-layer portion 22, including the frame member 4, electrode catalyst layer 3, and electrolyte membrane 2, are sequentially formed from the circumferential edge 2a of the electrode catalyst layer 2 to the margin 4b of the opening 4a.

### <Protecting-Bonding-Layer Step>

Next, as shown in FIG. 7E, a protecting-bonding-layer step is executed to cover the bonding layer 43, provided outside the electrolyte membrane 2, with a protective sheet 42 in a frame shape to protect the bonding layer 43.

### <Suctioning Step>

FIG. 7B is a schematic cross-sectional view of the membrane electrode assembly 10 to illustrate a suctioning step of the manufacturing method for the membrane electrode assembly 10. Subsequently, as shown in FIG. 7B, the suctioning step is executed to suction the protective sheet 6, electrolyte membrane 2, electrode catalyst layer 3, and frame member 4 placed on the suction plate 5, by the suction mechanism 8 via the porous suction plate 5, toward the suction plate 5 (in a direction indicated by arrowed lines “d”), to cause the sucked components to be suctioned all over to the suction plate 5.

### <Holding-and-Cutting-Adhesive-Tape Step>

FIG. 7C is a schematic cross-sectional view to illustrate a holding-and-cutting-adhesive-tape step of the manufacturing method for the membrane electrode assembly 10. Subsequently, as shown in FIG. 7C, the holding-and-cutting-adhesive-tape step is executed to bend one end 7a of the adhesive tape 7 so as to be folded and hold the folded portion with a tape clamp 92 and then cut the other end 7b of the adhesive tape 7 with a tape cutter 93 so as to have a suitable length. In this case, the tape cutter 93 is preferably a tape cutter device with a tip bending mechanism including the tape clamp 92.

### <Correcting-Tape-Posture Step>

FIG. 7D is a schematic cross-sectional view to illustrate a correcting-tape-posture step of the manufacturing method for the membrane electrode assembly 10. Subsequently, as shown in FIG. 7D, the tape clamp 92 is used to hold one end 7a of the adhesive tape 7. The correcting-tape-posture step is executed to use a tape roller 95 to press the adhesive tape 7 toward a depressor 94 (direction indicated by allowed lines “e”) so as to be bent in a desired shape, to correct a posture of the tape, while the other end 7b of the adhesive tape 7 is supported by the depressor 94.

### <Sticking-Adhesive-Tape Step>

FIG. 7E is a schematic cross-sectional view of the key portions to illustrate a sticking-adhesive-tape step of the manufacturing method for the membrane electrode assembly 10. Subsequently, a sticking-adhesive-tape step is executed to stick the adhesive tape 7 for peeling to the outermost edge 6a of the protective sheet 6 in FIG. 7E. During the sticking-adhesive-tape step, the other end 7b of the adhesive tape 7 is depressed by the depressor 94 on a top surface of a circumferential portion of the protective tape 6 toward the protective sheet (direction indicated by allowed lines “g”) and securely stuck, so as to be disposed from a top of the two-layer portion 21 to a top of the three-layer portion 22.

### <Peeling-Protective-Sheet Step>

FIG. 7F is a schematic cross-sectional view of the key portions to illustrate a peeling-protective-sheet step of the manufacturing method for the membrane electrode assembly 10. FIG. 7G is a schematic plan view to illustrate a peeling-protective-sheet step of the manufacturing method for the membrane electrode assembly 10. Subsequently, a peeling-protective-sheet step is executed to peel the protective tape 6, as shown in FIGS. 7F and 7G. First, a pulling-up step is executed to pull up the tape claim 92 holding the one end 7a of the adhesive tape 7 in a separating direction (direction indicated by an allowed line “h”) to peel a corner 6b of the protective sheet 6, while a bent portion 6c of the protective sheet 6 is depressed by the depressor 94 toward the electrolyte membrane 2 (in a direction indicated by an allowed line “f”). The pulling-up step and peeling-protective-sheet step are executed while the membrane electrode assembly 10 is suctioned toward the suction plate 5 (in the direction indicated by the allowed lines “d”) by the suction mechanism 8, to prevent the membrane electrode assembly 10 from being peeled from the suction plate 5 (see FIG. 7B).

Additionally, as shown in FIG. 7G, the tape claim 92 pulling the adhesive tape 7 is moved in a diagonal direction (direction indicated by the allowed line “b”) of the protective sheet 6 from the corner 6b, while the bent portion 6c of the protective sheet 6 is supported by the tape roller 9 for correcting tape posture, to peel the protective sheet 6. In this manner, the protective sheet 6 is easily peeled from the electrolyte membrane 2.

### <Disposing-Adhesive-Tape-and-Protective-Sheet Step>

Subsequently, a disposing-adhesive-tape-and-protective-sheet step is executed to dispose the peeled adhesive tape 7 and protective sheet 6 into a disposal box. This completes all the steps of the manufacturing method for the membrane electrode assembly.

As described above, the present invention in FIG. 1 provides a manufacturing method for the membrane electrode assembly 10 to join the electrolyte membrane 2, having the protective sheet 6 affixed thereto, and the electrode catalyst layer 3 laminated on the opposite side of the electrolyte membrane 2 to the protective sheet 6 with the frame member 4 having the opening 4a in the center and layered with the circumferential portions of the electrolyte membrane 2 and electrode catalyst layer 3 to manufacture the membrane electrode assembly 10, the method including: the placing-frame-member step of placing the frame member 4 on the suction plate 5; the placing-electrode-catalyst-layer step of placing the electrode catalyst layer 3 on the frame member 4 so as to have the circumferential edge 3a of the electrode catalyst layer 3 overlapped with the margin 4b of the opening 4a; the placing-electrolyte-membrane step of placing the electrolyte membrane 2 on the opposite side of the electrode catalyst layer 3 to the frame member 4; and the peeling-protective-sheet step of peeling the protective sheet 6 after the electrolyte membrane 2 has been laminated, wherein the circumferential edge 2a of the electrolyte membrane 2 is placed beyond the circumferential edge 3a of the electrode catalyst layer 3, the two-layer portion 21, having the frame member 4 layered with the electrolyte membrane 2, and the three-layer portion 22, having the frame member 4 layered with the electrode catalyst layer 3 and electrolyte membrane 2, are sequentially formed in the placing-electrolyte-membrane step from the circumferential edge 2a of the electrode catalyst layer 2 to the margin 4b of the opening 4a, and the protective sheet is peeled in the peeling-protective-sheet step from the two-layer portion 21 toward the three-layer portion 22.

According to such a configuration of the present invention, the circumferential edge 2a of the electrolyte membrane 2 is placed beyond the circumferential edge 3a of the electrode catalyst layer 3, to have the two-layer portion 21, having the frame member 4 layered with the electrolyte membrane 2, and the three-layer portion 22, having the frame member 4 layered with the electrode catalyst layer 3 and electrolyte membrane 2, in an outside-in order. Accordingly, the two-layer portion 21 of the electrolyte membrane 2 and frame member 4 works as an adhesive interface at a peeled point, and is away from the electrode catalyst layer 3. This allows for peeling only the protective sheet 6 from the membrane electrode assembly 10, when the protective sheet 6 is peeled, while influence to the electrode catalyst layer 3 is reduced.

In addition, the suction plate 5 in FIG. 1 is part of the conveying mechanism 50 to convey the membrane electrode laminate 1.

According to such a configuration, the suction plate 5 being part of the conveying mechanism 50 to convey the membrane electrode laminate 1 allows moving the suction plate 5 to cause the entire membrane electrode laminate 1 to be moved, to have the membrane electrode assembly 10 effectively manufactured.

Further, as shown in FIG. 7B, the suction mechanism 8 to suction the suction plate 5 is provided for the suction plate 5, and the suction mechanism 8 suctions the suction plate 5 in the peeling-protective-sheet step.

According to such a configuration, as shown in FIG. 4, the suction mechanism 8 suctions the suction plate 5 with a suctioning force F20 when the protective sheet 6 is peeled with a peeling force F10, to have the electrode catalyst layer 3 and electrolyte membrane 2 suctioned in a direction opposite to the direction of the protective sheet 6 being peeled. This reduces the electrode catalyst layer 3 and electrolyte membrane 2 from being lifted in the direction of the protective sheet 6 being peeled, in the peeling-protective-sheet step. An adhesive force F2 between the protective sheet 6 and electrolyte membrane 2 is set smaller than an adhesive force F3 between the electrolyte membrane 2 and electrode catalyst layer 3.

Still further, the peeling-protective-sheet step includes the sticking-adhesive-tape step of sticking the adhesive tape 7 for peeling to the outermost edge 6a of the protective sheet 6, shown in FIG. 7E, and the pulling-up step of pulling up the adhesive tape 7, shown in FIG. 7F, with an adhesive force F1 (see FIG. 1) in the pulling-up step between the adhesive tape 7 and protective sheet 6 set larger than an adhesive force F4 (see FIG. 1) between the frame member 4 and electrolyte membrane 2.

According to such a configuration, as shown in FIG. 1, the membrane electrode assembly 10 has the adhesive force F1 between the adhesive tape 7 and protective sheet 6 set larger than the adhesive force F4 between the frame member 4 and electrolyte membrane 2. As shown in FIGS. 2 and 3, this prevents the electrolyte membrane 2 from being separated, and thus peeled, from the frame member 4 in the pulling-up step. Accordingly, the membrane electrode assembly 10 allows for peeling only the protective sheet 6 when the protective sheet 6 is peeled from the electrolyte membrane 2.

Still further, as shown in FIGS. 7E and 7F, the membrane electrode assembly 10 (for a fuel cell) is formed to join the electrolyte membrane 2 and the electrode catalyst layer 3, laminated on the electrolyte membrane 2, with the frame member 4 (first frame member) having the opening 4a in the center and layered with the electrolyte membrane 2 and the circumferential portion 3a of the electrode catalyst layer 3, wherein the circumferential edge 2a of the electrolyte membrane 2 is placed beyond the circumferential edge 3a of the electrode catalyst layer 3, the two-layer portion 21 having the frame member 4 layered with the electrolyte membrane 2 and the three-layer portion 22 having the frame member 4 layered with the electrode catalyst layer 3 and electrolyte membrane 2 are sequentially formed from the circumferential edge 2a of the electrolyte membrane 2 to the margin 4b of the opening 4a.

According to such a configuration, as shown in FIGS. 1 and 2, the membrane electrode assembly 10 has the two-layer portion 21 and three-layer portion 22 formed from the circumferential edge 2a of the electrode catalyst layer 2 to the margin 4b of the opening 4a. Accordingly, the electrolyte membrane 2 is securely joined to the frame member 4, with the circumferential edge 2a entirely covering the circumferential portion 3a of the electrode catalyst layer 3, to have a wide joining area. This allows the electrolyte membrane 2 to be securely joined to the frame member 4, so as to be prevented from being peeled from the frame member 4.

### Modifications

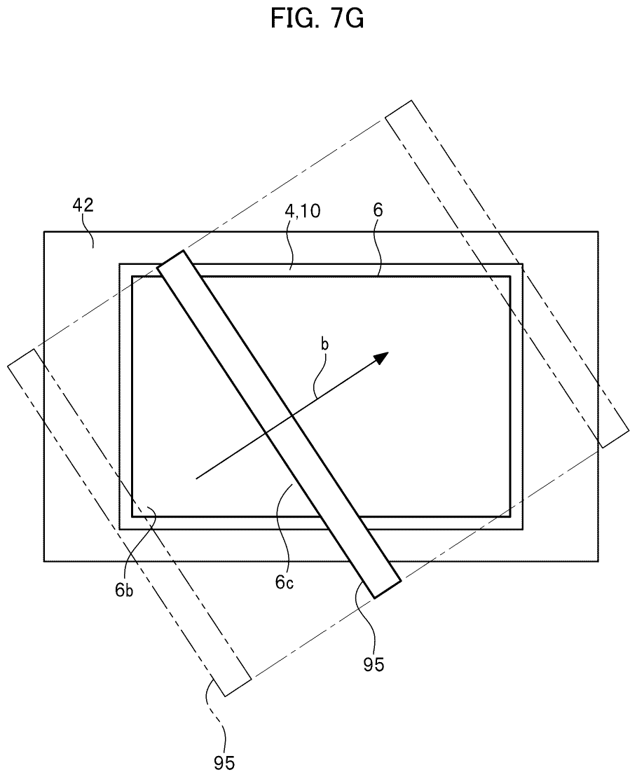

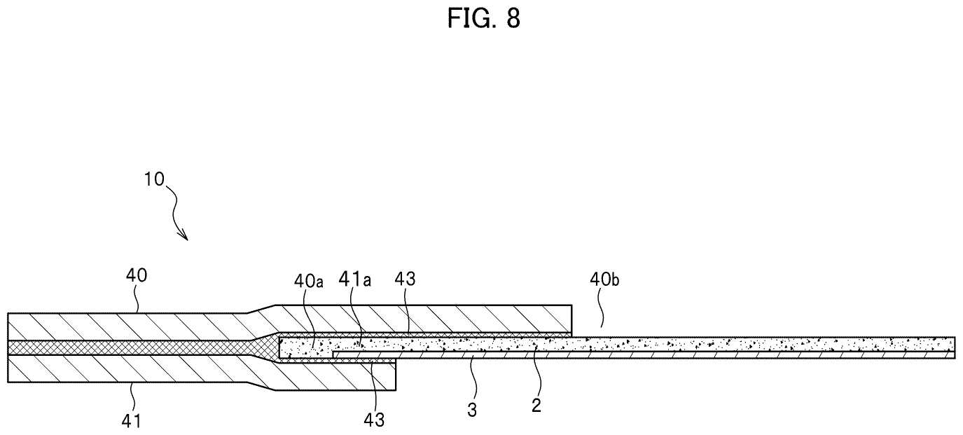

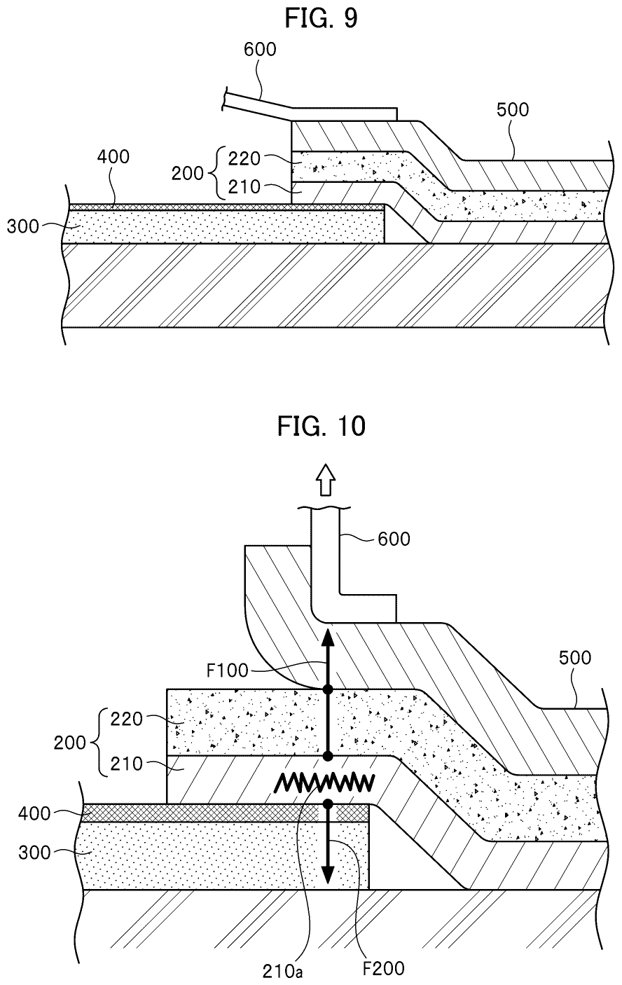

Note that the present invention is not limited to the embodiment and can be variously altered and/or modified within the scope of the technical idea, and it is needless to say that the present invention also includes these alterations and/or modifications. FIG. 8 is a schematic cross-sectional view of a modification of the membrane electrode assembly for a fuel cell, according to the embodiment of the present invention.

For example, as shown in FIG. 8, a second frame member 40 having an opening 40b in the center is joined to a surface of a first frame member 41, which is closer to the electrolyte membrane 2 than the other, via the bonding layers 43. The membrane electrode laminate 1 has a two-layer portion 40a, having the first frame member 41 layered with the electrolyte membrane 2, and a three-layer portion 41a, having the first frame member 41 layered with the electrode catalyst layer 3 and electrolyte membrane 2. The first frame member 41 and second frame member 40 are arranged to hold the two-layer portion 40a and three-layer portion 41a therebetween.

This allows the first frame member 41 and second frame member 40 to be arranged to hold the two-layer portion 40a and three-layer portion 41a therebetween, to securely hold the two-layer portion 40a and three-layer portion 41a.

### LIST OF REFERENCE SIGNS

1, membrane electrode laminate; 2, electrolyte membrane; 2a, circumferential edge; 3, electrode catalyst layer; 3a, circumferential edge; 4, frame member (first frame member); 4a, opening; 4b, margin; 5, suction plate; 6, protective sheet; 6a, outermost edge; 7, adhesive tape; 8, suction mechanism; 10, membrane electrode assembly; 21, two-layer portion; 22, three-layer portion; 43, bonding layer; 50, conveying mechanism; and F1, F4, adhesive force.

What is claimed is:

1. A manufacturing method for a membrane electrode assembly to join an electrolyte membrane, having a protective sheet affixed thereto, and an electrode catalyst layer laminated on an opposite side of the electrolyte membrane to the protective sheet with a frame member having an opening in the center and layered with circumferential portions of the electrolyte membrane and electrode catalyst layer to manufacture a membrane electrode assembly, the method comprising:
a placing-frame-member step of placing the frame member on a suction plate;
a placing-electrode-catalyst-layer step of placing the electrode catalyst layer on the frame member so as to have a circumferential edge of the electrode catalyst layer overlapped with a margin of the opening;
a placing-electrolyte-membrane step of placing an electrolyte membrane on an opposite side of the electrode catalyst layer to the frame member; and
a peeling-protective-sheet step of peeling the protective sheet after the electrolyte membrane has been laminated,
wherein
a circumferential edge of the electrolyte membrane is placed beyond the circumferential edge of the electrode catalyst layer, and
a two-layer portion, having the frame member layered with the electrolyte membrane, and a three-layer portion, having the frame member layered with the electrode catalyst layer and electrolyte membrane, are sequentially formed in the placing-electrolyte-membrane step from the circumferential edge of the electrolyte membrane to the margin of the opening.

2. The method according to claim 1, wherein
the suction plate is part of a conveying mechanism to convey a membrane electrode laminate composed of the electrolyte membrane and electrode catalyst layer.

3. The method according to claim 1, wherein
a suction mechanism to suction the suction plate is provided for the suction plate, and
the suction mechanism suctions the suction plate in the peeling-protective-sheet step.

4. The method according to claim 1, wherein
the peeling-protective-sheet step includes:
a sticking-adhesive-tape step of sticking an adhesive tape for peeling to an outermost edge of the protective sheet, and
a pulling-up step of pulling up the adhesive tape, and
an adhesive force in the pulling-up step between the adhesive tape and protective sheet is set larger than an adhesive force between the frame member and electrolyte membrane.

5. A membrane electrode assembly formed to join an electrolyte membrane and an electrode catalyst layer, laminated on the electrolyte membrane, with a first frame member having an opening in the center and layered with the electrolyte membrane and a circumferential portion of the electrode catalyst layer,
wherein
a circumferential edge of the electrolyte membrane is placed beyond a circumferential edge of the electrode catalyst layer, and
a two-layer portion, having the first frame member layered with the electrolyte membrane, and a three-layer portion, having the first frame member layered with the electrode catalyst layer and electrolyte membrane, are sequentially formed from the circumferential edge of the electrolyte membrane to a margin of the opening.

6. The membrane electrode assembly according to claim 5, wherein
a second frame member having an opening in the center is joined to a surface of the first frame member, which is closer to the electrolyte membrane than the other, via bonding layers, and
the first frame member and second frame member hold the two-layer portion and three-layer portion therebetween.
